(19) United States
(12) Patent Application Publication
(10) Pub. No.: US 2007/0086836 A1
(43) Pub. Date: Apr. 19, 2007

(54) Ring binder mechanism with operating lever and travel bar

(75) Inventor: Hung Yu Cheng, Hong Kong (CN)

Correspondence Address: SENNIGER POWERS, ONE METROPOLITAN SQUARE, 16TH FLOOR, ST LOUIS, MO, 63102, US

(73) Assignee: World Wide Stationery Mfg. Co., Ltd., Hong Kong (CN)

(21) Appl. No.: 11/229,878

(22) Filed: Sep. 19, 2005

(51) Int. Cl. B42F 13/20

(52) U.S. Cl. 402/37

(57) ABSTRACT

A ring mechanism for retaining loose-leaf pages having a housing, hinge plates, and ring members. The housing supports the hinge plates for pivoting motion relative to the housing to open and close ring members mounted thereon. The mechanism includes a travel bar mounted for translational movement along the longitudinal axis of the housing. An actuating lever is provided secured for pivotal movement to the housing. The actuating lever has a handle portion projecting above the housing for manually pivoting movement of the actuating lever. An actuator portion which extends through an opening in the central top portion of the housing is engageable with the hinge plates to pivot them between the open and closed positions and further is engageable with the travel bar to move it between locked and unlocked positions.

### BACKGROUND OF THE INVENTION

This invention relates generally to a ring mechanism for retaining loose-leaf pages and more particularly to an improved mechanism for opening and closing ring members and for locking closed ring members together.

A ring mechanism typically retains loose-leaf pages, such as hole-punched papers, in a file or notebook. A pair of hinge plates is supported within a housing in joined relation for loose pivoting motion relative to the housing. The housing is generally narrower than the joined hinge plates when they are in a coplanar position (180°). So as the hinge plates pivot through the coplanar position, they deform the housing and cause a spring force that urges them to pivot either upward or downward. Ring members mounted on the hinge plates move with the pivoting movement of the hinge plates. The ring members open when the hinge plates pivot upward and close when the hinge plates pivot downward.

Some ring mechanisms include structure such as, for example, control slides located between the housings and the hinge plates to lock the ring members together when they close. The control slides engage upper surfaces of the hinge plates and block the hinge plates from pivoting upward when it is desired to hold the closed ring members together. The control slides move to a position allowing the hinge plates to pivot freely when it is desired to open the ring members. These mechanisms can be difficult to make, however, because the control slides are generally installed within the housings before the hinge plates. Consequently, proper positioning of the control slides relative to the hinge plates can be difficult. Additionally, the control slides may have a complex shape to interact with the hinge plates. This can increase production costs of ring mechanisms incorporating these control slides.

Accordingly, it would be desirable to provide a ring mechanism that is easy to make and includes a simplified travel bar.

### SUMMARY OF THE INVENTION

A ring mechanism generally comprises a housing having a longitudinal axis, a central top portion having an opening defined therein and an open bottom generally opposed to the central top portion. A pair of hinge plates each having an upper surface and a lower surface are supported by the housing for pivoting movement relative to the housing, with the upper surface generally facing the housing. At least one ring for holding loose-leaf pages includes a first ring member and a second ring member. The first ring member is mounted on a first hinge plate and moveable with the pivoting motion of the first hinge plate relative to the second ring member between a closed position and an open position. In the closed position the two ring members form a substantially continuous, closed loop for allowing loose-leaf pages retained by the rings to be moved along the rings from one ring member to the other, and in the open position the two ring members form a discontinuous, open loop for adding or removing loose-leaf pages from the rings. A travel bar disposed within the housing and supported for movement translationally along the longitudinal axis of the housing is adapted to affect the pivoting motion of the hinge plates. An actuating lever secured for pivotal movement to the housing has a handle portion projecting above the housing for allowing manual pivotal movement of the actuating lever. An actuator portion extending through the opening in the central top portion of the housing is engageable with the hinge plates to pivot them between the open and closed positions and is further operatively connected to the travel bar to move the travel bar generally along the longitudinal axis of the housing.

Other features of the invention will be in part apparent and in part pointed out hereinafter.

### BRIEF DESCRIPTION OF THE DRAWINGS

FIG. 1 is a perspective of a notebook incorporating a ring mechanism according to a first preferred embodiment of the invention;

FIG. 2 is a top perspective of the first preferred embodiment of the ring mechanism of the present invention with ring members at a closed and locked position;

FIG. 3 is an exploded top perspective of the first embodiment;

FIG. 4 is a bottom side perspective of the first embodiment of the ring mechanism with ring members at a closed and locked position;

FIG. 5 is a top side perspective of a portion of the first embodiment, with a housing removed and showing portions the actuating lever and travel bar;

FIG. 6 is an elevation of the portion of the mechanism shown in FIG. 5;

FIG. 7 is a sectional view in the direction of line 7-7 of FIG. 2;

FIG. 8 is a perspective similar to FIG. 2, but with the actuating lever in a slightly raised, unlocked position;

FIG. 9 is a bottom side perspective of the first embodiment as shown in FIG. 8;

FIG. 10 is a top side perspective of a portion of the first embodiment, with the housing removed and showing portions the actuating lever and travel bar in the positions of FIGS. 9 and 10;

FIG. 11 is an elevation similar to that of FIG. 6, but with the actuating lever in the position shown in FIGS. 9 and 10;

FIG. 12 is a top perspective of the first embodiment of the ring mechanism of the present invention with ring members at an open and unlocked position;

FIG. 13 is a bottom side perspective of the first embodiment of the ring mechanism with ring members at an open and unlocked position;

FIG. 14 is a top side perspective of a portion of the first embodiment, showing portions the actuating lever and travel bar in the positions of FIGS. 12 and 13;

FIG. 15 is an elevation of the portion of the mechanism shown in FIG. 14;

FIG. 16 is a top perspective of the second embodiment of the ring mechanism of the present invention with ring members at a closed and locked position;

FIG. 17 is an exploded top perspective of the second embodiment;

FIG. 18 is a bottom side perspective of the second embodiment of the ring mechanism with ring members at a closed and locked position;

FIG. 19 is a top side perspective of a portion of the second embodiment, with a housing removed and showing portions the actuating lever and travel bar;

FIG. 20 is a fragmentary longitudinal section of the second embodiment with part of a travel bar broken away;

FIG. 21 is a sectional view in the direction of line 21-21 of FIG. 20;

FIG. 22 is a perspective similar to FIG. 16, but with the actuating lever in a slightly raised, unlocked position;

FIG. 23 is a bottom side perspective of the second embodiment as shown in FIG. 22;

FIG. 24 is a top side perspective of a portion of the second embodiment, with the housing removed and showing portions the actuating lever and travel bar in the positions of FIGS. 22 and 23;

FIG. 25 is a fragmentary longitudinal section similar to that of FIG. 20, but with the actuating lever in the position shown in FIGS. 23 and 24;

FIG. 26 is a top perspective of the second embodiment of the ring mechanism of the present invention with ring members at an open and unlocked position;

FIG. 27 is a bottom side perspective of the second embodiment of the ring mechanism with ring members at an open and unlocked position;

FIG. 28 is a top side perspective of a portion of the second embodiment, with the housing removed and showing portions the actuating lever and travel bar in the positions of FIGS. 26 and 27; and

FIG. 29 is a fragmentary longitudinal section similar to that of FIG. 20, but with the actuating lever in the position shown in FIGS. 26-28.

Corresponding reference characters indicate corresponding parts throughout the views of the drawings.

### DETAILED DESCRIPTION

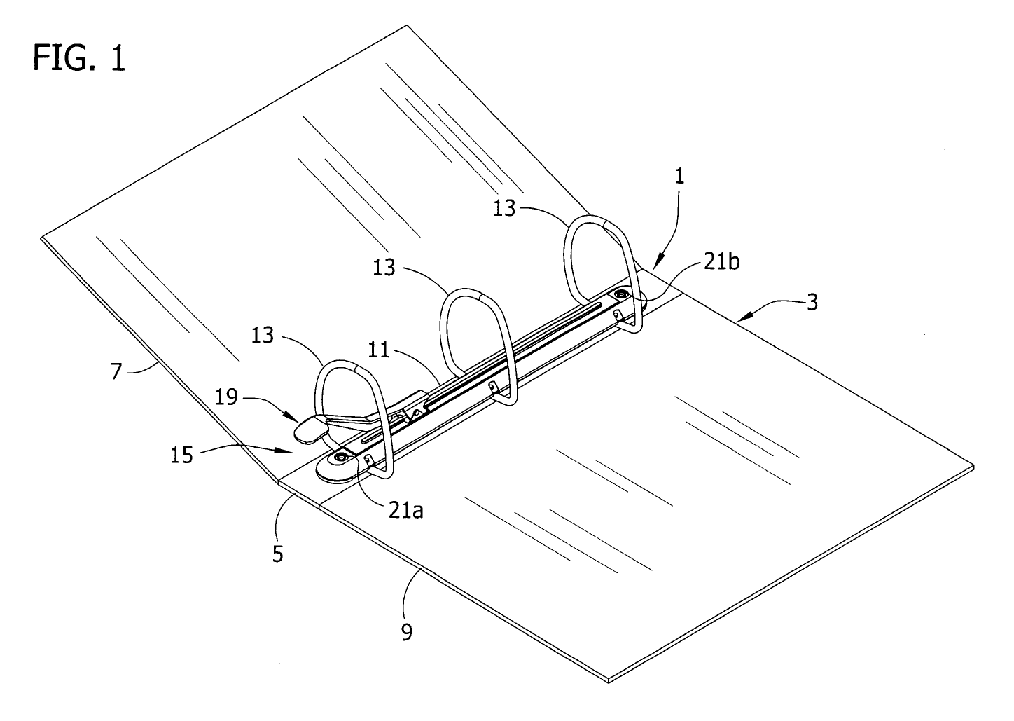

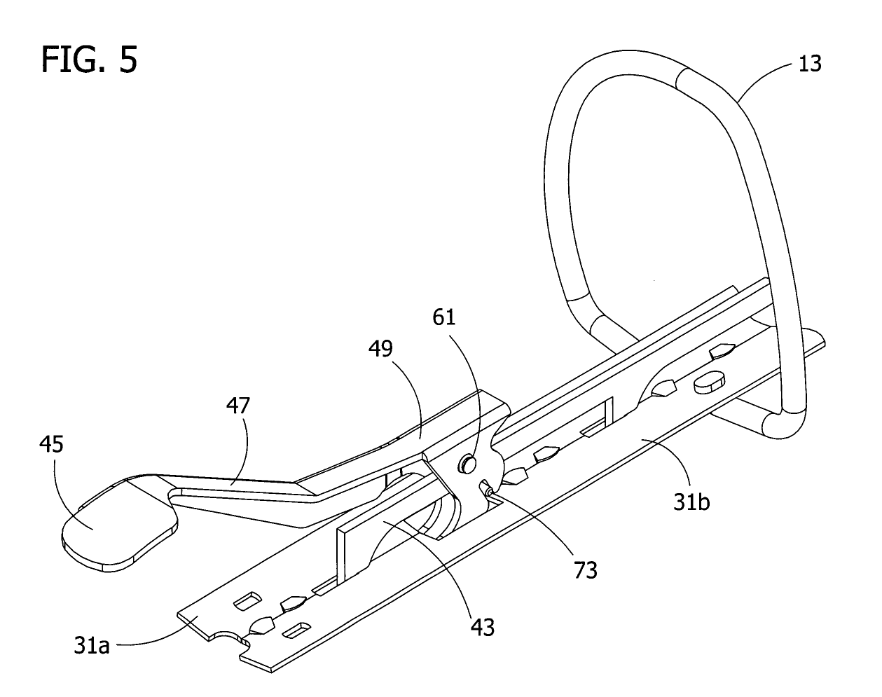

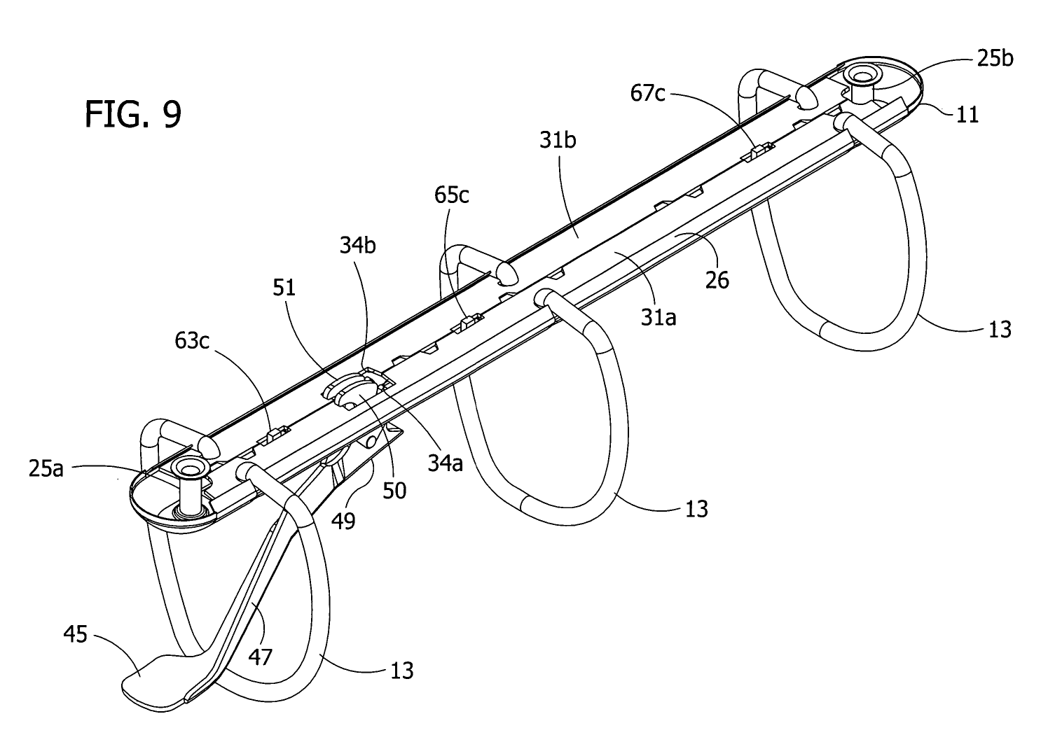

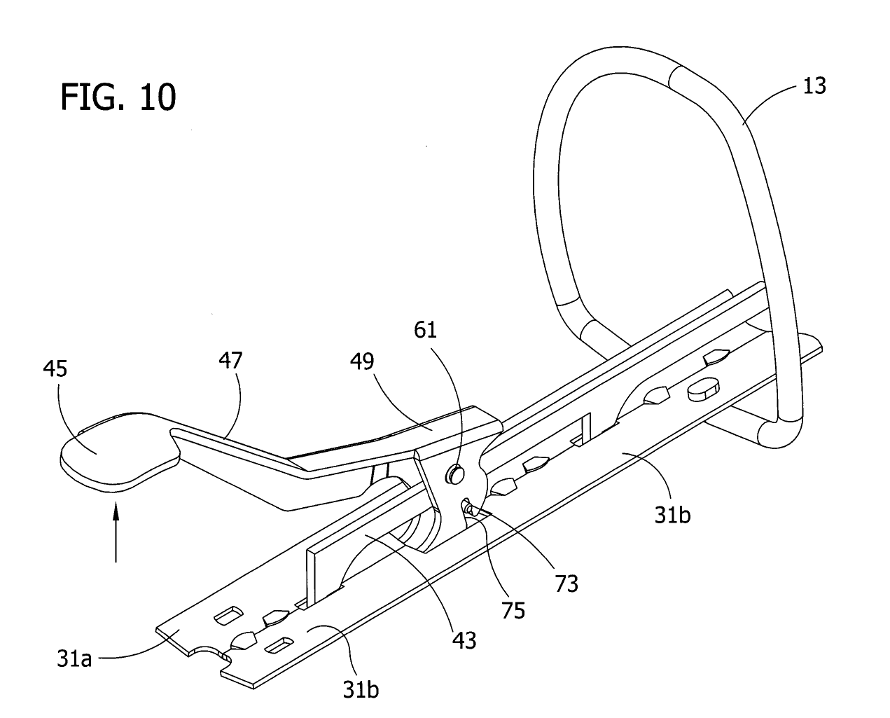

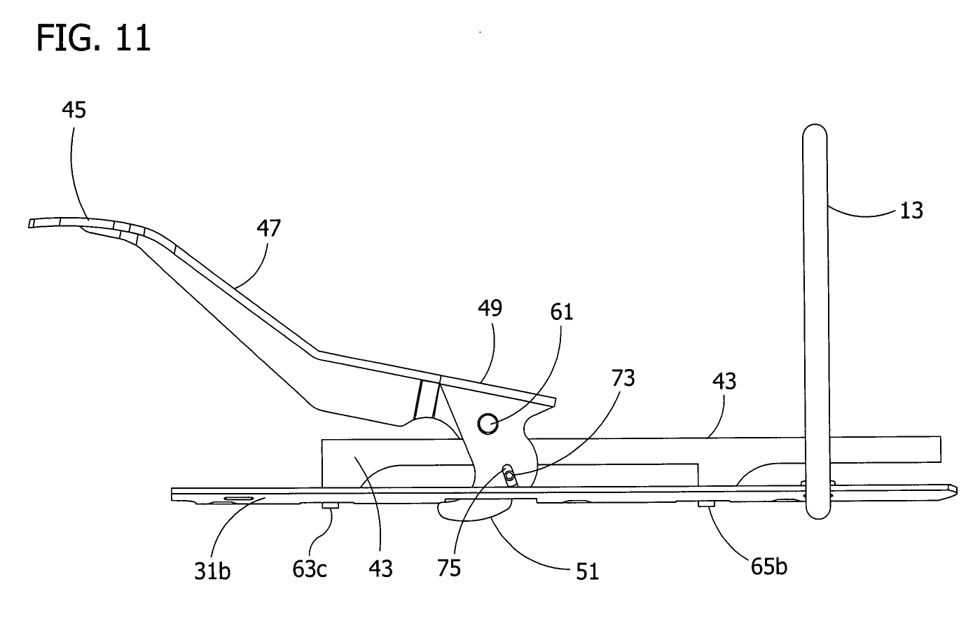

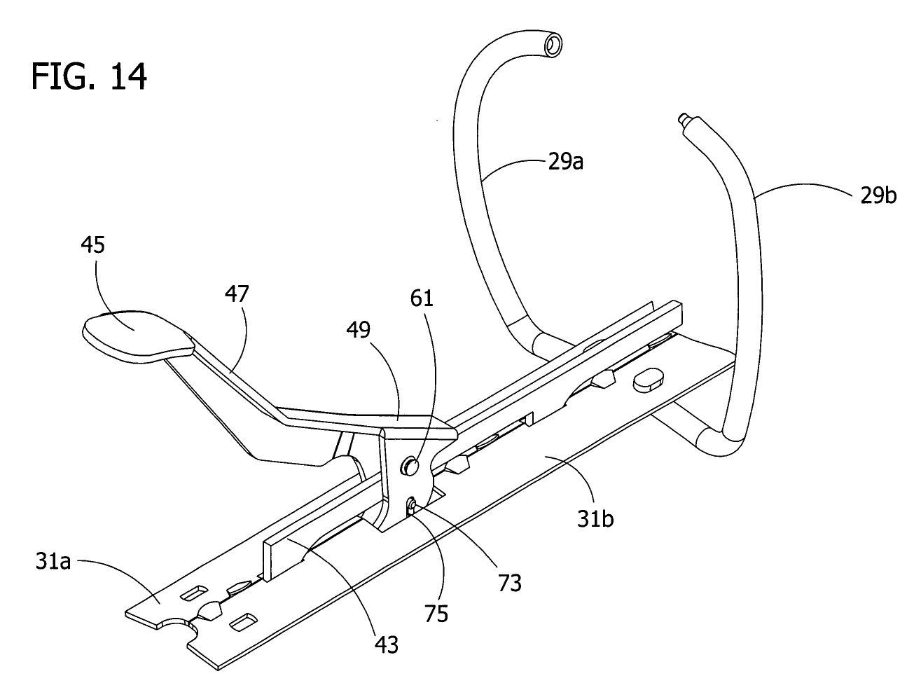

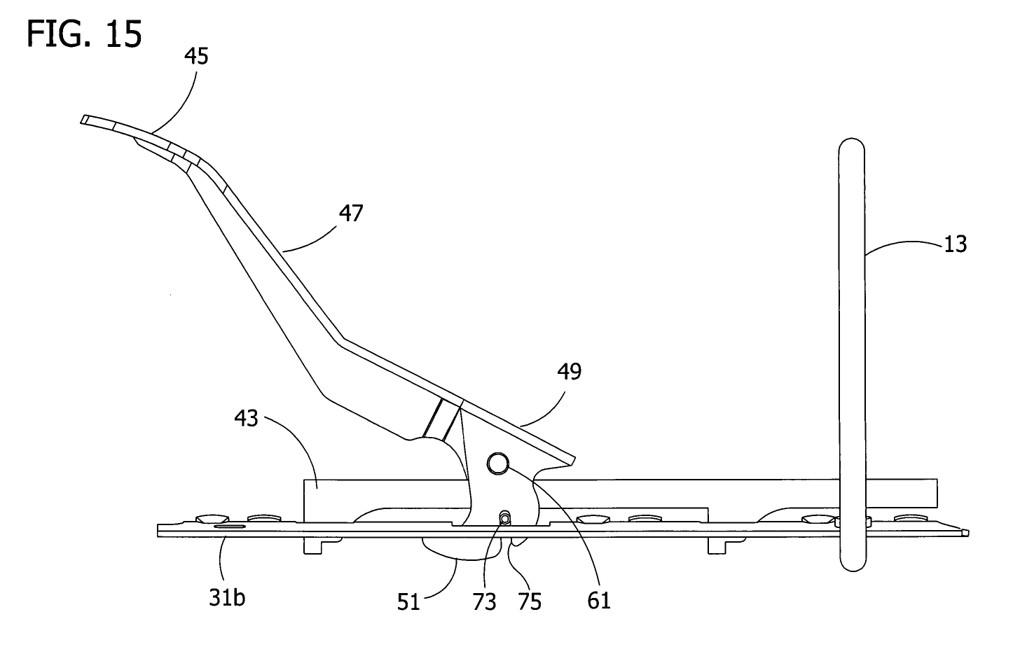

Referring now to the drawings, FIGS. 1-15 show a first embodiment of the ring mechanism of the present invention generally at reference numeral 1. The mechanism is shown in FIG. 1 mounted on a notebook, designated generally by reference numeral 3. In particular, it is shown mounted on a spine 5 of notebook 3 between a front cover 7 and a back cover 9. The front and back covers are hingedly attached to spine 5 for moving to selectively cover or expose loose-leaf pages (not shown in the drawings) retained by mechanism 1. A ring mechanism mounted on a surface other than a notebook, for example a file, does not depart from the scope of this invention.

The terms “forward” and “rearward” are used herein to describe relative orientation of components of ring mechanism 1. “Forward” refers to the right of the ring mechanism as viewed in FIG. 1 and “rearward” refers to the left of the ring mechanism. These terms do not limit the invention in any way.

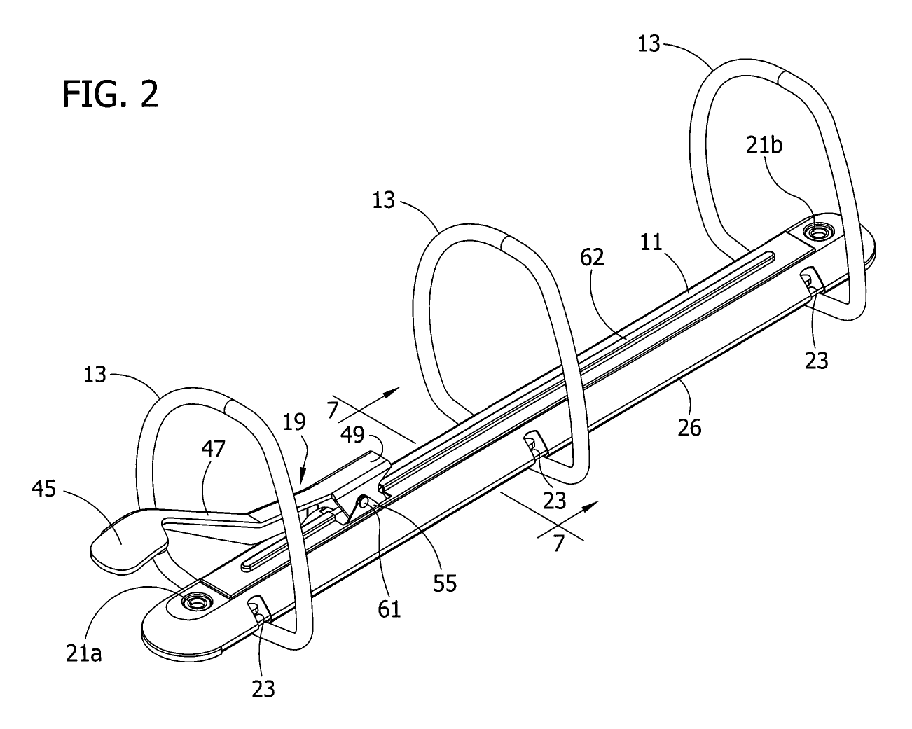

As shown in FIGS. 1 and 2, ring mechanism 1 generally includes an elongated housing, designated generally by reference numeral 11, three substantially identical rings, each designated generally by reference numeral 13, and a control structure, designated generally by reference numeral 15. Housing 11 supports rings 13 and control structure 15 for closing and opening operation of mechanism 1 to retain, add, or remove pages. This operation will be described in greater detail hereinafter.

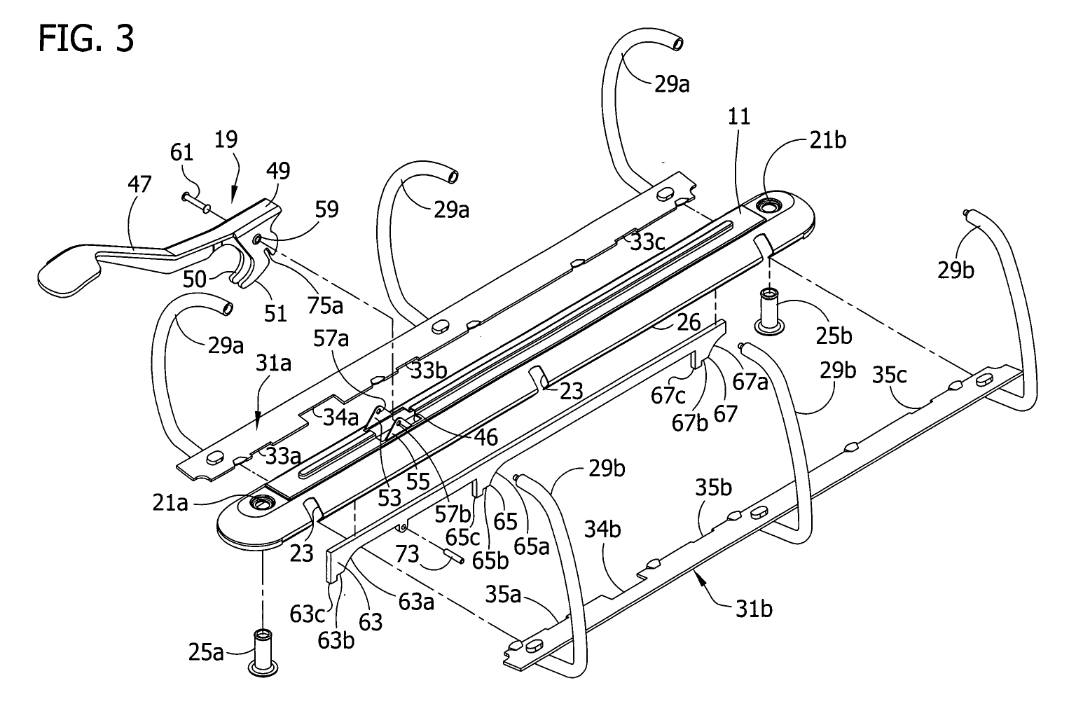

Referring to FIG. 3, components of ring mechanism 1 are shown in exploded perspective. Housing 11 is elongate with a uniform, generally arch-shaped cross section having a central top portion and an open bottom generally opposed to the central top portion. Housing 11 also includes opposing longitudinal ends, both of which are closed with a rounded structure. An actuating lever 19 is mounted on the housing 11. Its structure and operation will be described in further detail hereinafter. A ring mechanism having a housing with a different shape, including an irregular shape, or a housing integral with a file or notebook does not depart from the scope of this invention.

Housing 11 includes multiple openings, including two mounting post openings 21a, 21b and six ring openings, three on each side of housing 11, (each designated by reference numeral 23). The openings 23 on only one side of the housing 11 may be seen in the drawings. The openings on the other side of the housing 11 have a shape generally similar to the illustrated openings 23. Ring openings 23 allow rings 13 to move relative to housing 11 to open and close during operation of ring mechanism 1. Mounting post openings 21a, 21b are located along the top surface of housing 11 toward opposite longitudinal ends. The openings 21a, 21b receive and attach mounting posts 25a, 25b, respectively, to housing 11 for use in securing mechanism 1 to notebook spine 5 (FIG. 1).

Housing 11 also includes two opposite, lower bent rims 26 (only one rim is visible in FIG. 3), extending along a respective longitudinal edge margin of the housing. As will be described in greater detail hereinafter, rims 26 support opening and closing movement of rings 13.

Also shown in FIG. 3 are ring members 29a, 29b that form each of rings 13. Ring members 29a each have a roughly semicircular, C-shaped profile, while ring members 29b each have a squared-off, half box-shaped profile. Together, the ring members 29a, 29b form what is known as a D-ring. It is envisioned that both ring members 29a, 29b are formed from a conventional, cylindrical rod of a suitable material such as steel. But ring members having different cross-sections or formed from different materials do not depart from the scope of the invention. In addition, a mechanism with more or less than three rings, or with rings that form a different shape when closed does not depart from the scope of this invention.

FIG. 3 shows ring members 29a, 29b mounted on two similar hinge plates designated generally by reference numerals 31a, 31b, respectively. The ring members are shown extending from upper surfaces of the hinge plates, but ring members extending from lower surfaces of hinge plates are within the scope of this invention. Ring members 29a, 29b are mounted on hinge plates 31a, 31b in a suitable manner. Although both ring members 29a, 29b move in illustrated mechanism 1, a mechanism having one movable ring member and one fixed does not depart from the scope of this invention (e.g., one ring member of each ring mounted on a hinge plate and one ring member mounted on a stationary housing).

Hinge plates 31a, 31b each have substantially the same shape. Each is thin, flat, and generally rectangular, and each includes three cutouts 33a-c and 35a-c, respectively. Cutouts 33a-c are located in hinge plate 31a in spaced apart relation along an inner longitudinal edge margin of the hinge plate. Cutouts 35a-c are correspondingly located in hinge plate 31b along an inner longitudinal edge margin of the hinge plate. More particularly, cutouts 33a, 33c and cutouts 35a, 35c are located toward opposite longitudinal ends of respective hinge plates 31a, 31b. Cutout 33b and cutout 35b are located inward and between end cutouts 33a, 33c and end cutouts 35a, 35c, respectively. A further set of two cutouts 34a and 34b are formed in the edge margins of hinge plates 31a and 31b. As will be described in regard to operation of ring mechanism 1, the cutouts accommodate portions of control structure 15 to allow either the pivoting movement of hinge plates 31a, 31b or block the pivoting movement.

Control structure 15 will now be described with particular reference to FIGS. 2-6. The control structure is best shown in FIG. 3 and includes the actuating lever 19 and a travel bar, designated generally by reference numeral 43. The travel bar may be made of any suitable material, such as sheet metal or plastic. As shown in FIG. 3, lever 19 has an enlarged head or handle portion 45, a main body 47 of generally L-shaped cross-section and an actuator portion 49 which extends through a rectangular opening 46 formed in the central top portion of housing 11. Head 45 is curved to facilitate gripping lever 19 to pivot it. Actuator portion 49 is formed with two generally hooked shaped arms 50 and 51 which extend down from the main body 47 through opening 46 in housing 11 and cutouts 34a and 34b in hinge plates 31a and 31b. Arm 50 is engageable with hinge plate 31a and arm 51 is engageable with hinge plate 31b from below. Lever 19 is supported on housing 11 by a pair of tabs 53 and 55 which extend upward from opposite sides of opening 46. A pair of aligned holes 57a and 57b formed in tabs 53 and 55 are also aligned with holes 59 formed, respectively, in arms 50 and 51 of actuator portion 49. Only the hole 59 formed in the arm 51 may be seen in the drawings. A pin 61 passes through holes 57a, 57b and 59 to hold the lever 19 for pivotal movement.

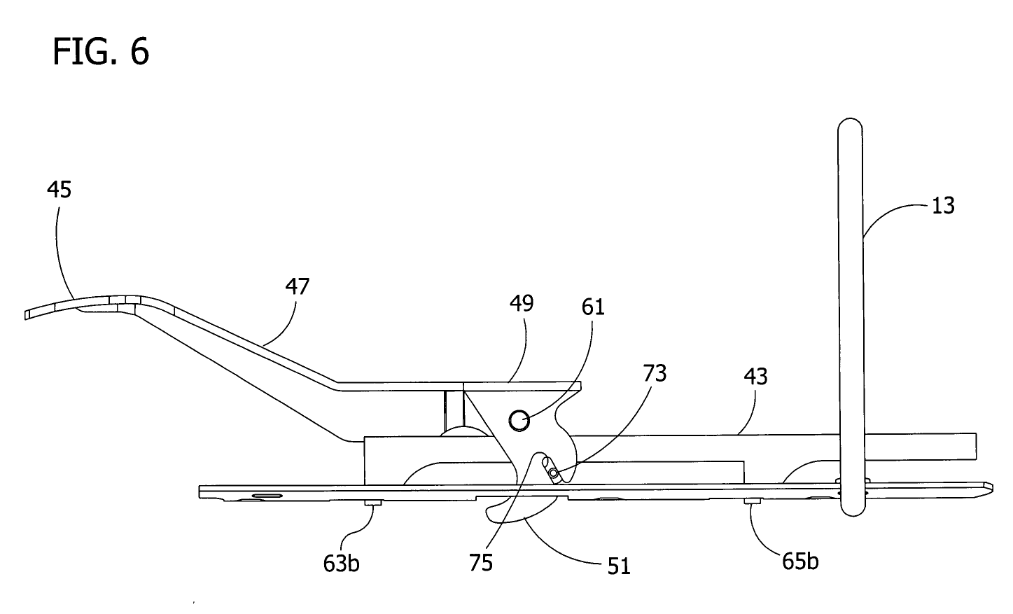

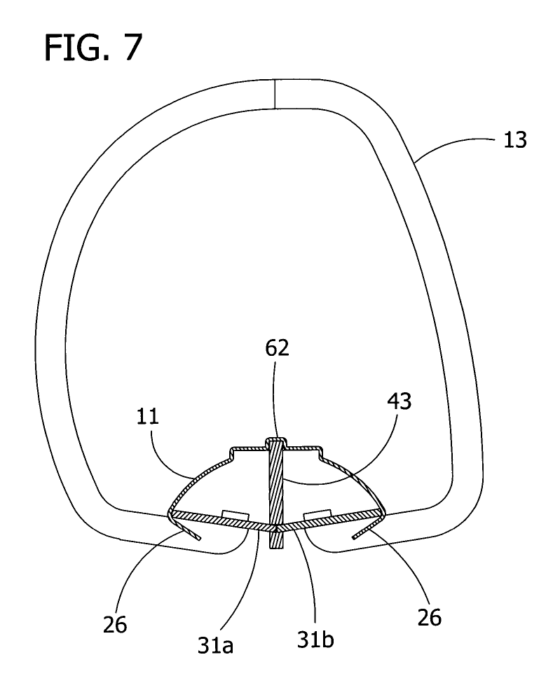

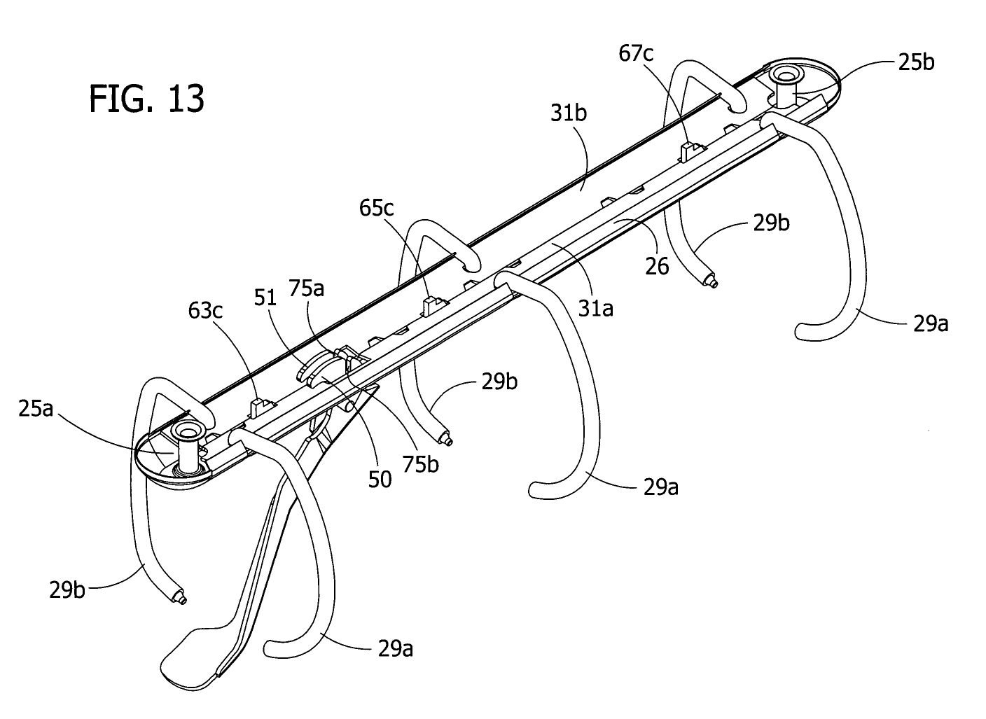

Referring again to FIGS. 3 and 7, travel bar 43 is thin, elongate, flat, and lies generally in a vertical plane (as oriented in FIG. 3). It is envisioned that travel bar 43 is stamped from a sheet of material, such as steel, and is free of bends. An upper edge of travel bar is flat and fits for sliding movement in a corresponding channel 62 formed in the central portion of housing 11, while a lower edge of the travel bar includes three locking elements in the form of camming members 63, 65 and 67 formed in the travel bar. The camming members 63, 65 and 67 have respective curved camming surfaces 63a, 65a and 67a each extending to a flat 63b, 65b and 67b next to a rectangular stop 63c, 65c and 67c. A further protrusion 69 is also formed in the lower edge of travel bar 43 and forms a hole 71 in which a pin 73 is force fitted whose ends are aligned with and received in slots 75a and 75b (see FIGS. 6 and 13) formed in respective arms 50 and 51 of actuator portion 49.

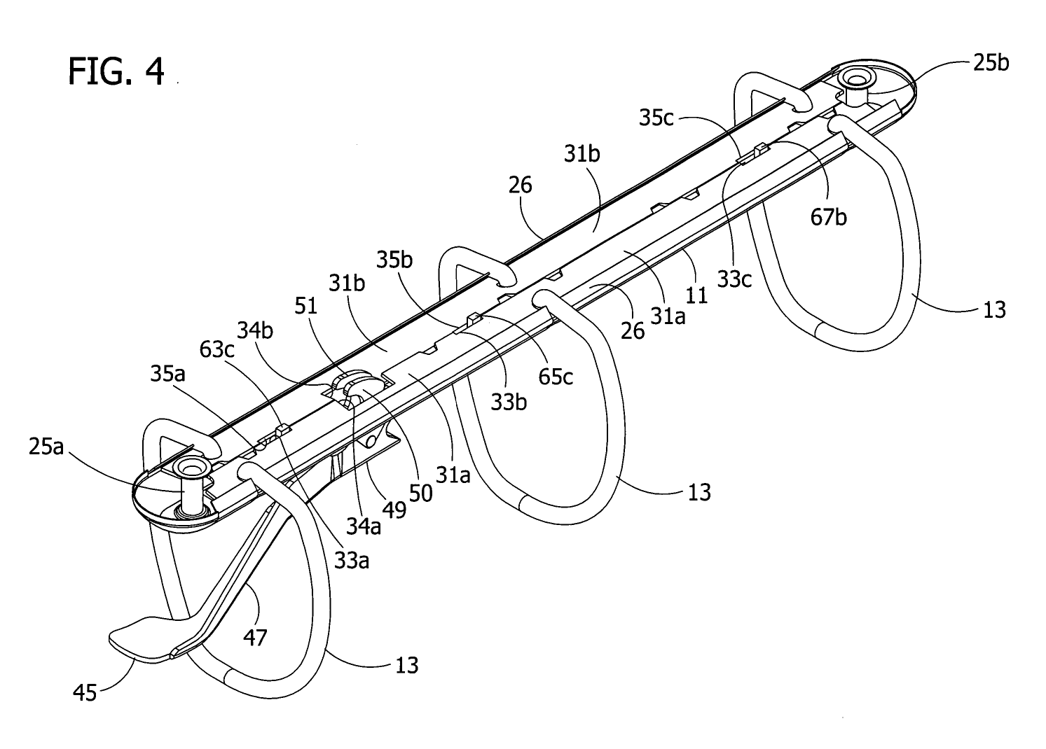

As shown, for example, in FIGS. 4 and 7, the hinge plates 31a, 31b are interconnected in parallel arrangement along their inner longitudinal edge margins, forming a central hinge. This is done in a conventional manner known in the art. The hinge plates 31a, 31b can pivot about the central hinge upward and downward. The six cutouts 33a-c and 35a-c in each of the two individual hinge plates 31a, 31b align to form three openings in the interconnected hinge plates. The housing 11 supports the interconnected hinge plates 31a, 31b with the bent rims 26 within the housing below the travel bar 43. The outer longitudinal edge margins of the hinge plates 31a, 31b loosely fit behind the bent under rims 26 of the housing 11 for allowing them to move within the rims when the hinge plates pivot.

Travel bar 43 is disposed above hinge plates 31a, 31b in general alignment with the hinge line formed by the margins of the hinge plates and, as mentioned above, its upper surface is received in the channel 62 formed in the central portion of housing 11 for sliding movement therein. A vertical plane containing travel bar 43 is oriented generally perpendicular to hinge plates 31a, 31b when in their coplanar position. Camming members 63-65 extend downward from travel bar 43 through respective cutout openings 33a-c and 35a-c of hinge plates 31a, 31b. As shown in the cross-sectional view of FIG. 7, travel bar 43 is held in position within channel 62 by the spring bias applied by the hinge plates 31a and 31b based on their containment within housing 11 and the force applied to the hinge plates from the flexibility of housing 11.

In operation, starting with the binder mechanism 1 in the closed and locked position, as illustrated in FIGS. 2-7, the travel bar 43 is positioned as far to the right as possible, as viewed in these figures, with the stops 63c, 65c and 67c of camming members 63-67 engaging the hinge plates 31a and 31b at the right end of the slots 35a-c so that the flats 63b, 65b and 67b lie against the upper surface of the hinge plates to prevent the hinge plates from being pivoted to open the rings 13. Any movement by the hinge plates 31a and 31b in an upward direction will simply attempt to push the travel bar 43 upward. However, this movement is blocked by engagement of the travel bar 43 with the housing 11 within the channel 62. Thus, the mechanism is in the locked position, holding the ring members 29a, 29b in the closed position. Note, as illustrated in FIG. 4, that the arms 50 and 51 do not engage and are spaced from the hinge plates in this position.

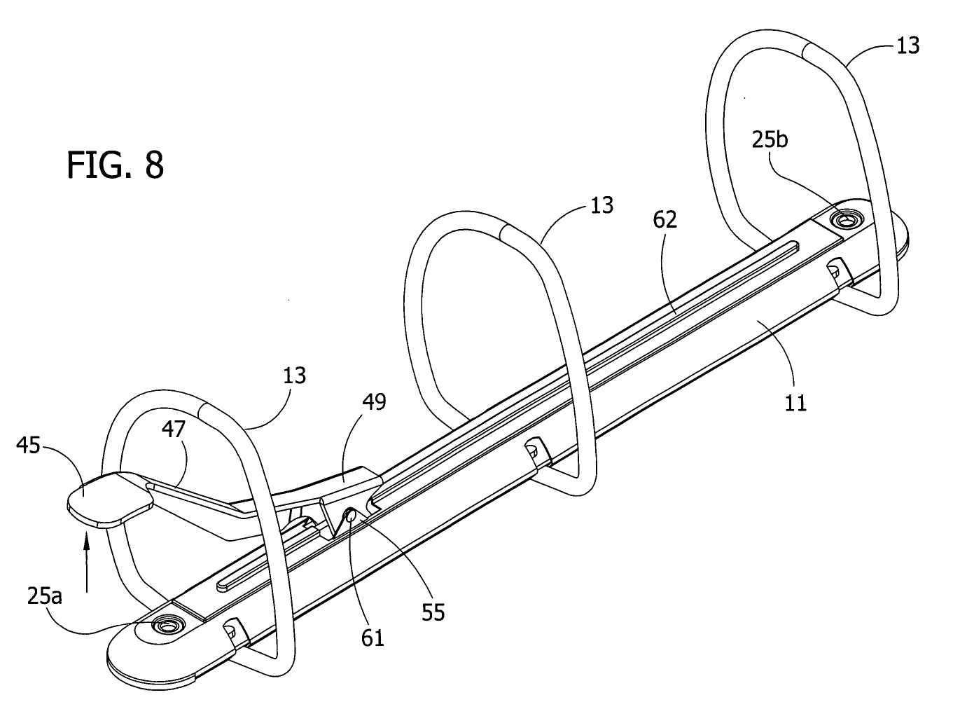

As seen in FIG. 8-11 as manual pressure is applied to head 45 of lever 19 as shown by the large arrows in FIGS. 8-11, the arms 50 and 51 of actuating portion 49 of lever 19 move into engagement with the lower surfaces of hinge plates 31a and 31b. At the same time, travel bar 43 is moved rearward (to the left) by movement of pin 73 in slots 75a and 75b in arms 50 and 51 and the flats 63b, 65b and 67b move into the openings formed by the cutouts 33a-c and 35a-c. Now the curved camming surfaces 63a, 65a and 67a on the travel bar engage the edges of the cutouts 33a-c and 35a-c. It will be appreciated that upward pivoting movement of the hinge plates 31a and 31b is no longer blocked by the travel bar 43. If the plates 31a and 31b are pivoting upward (e.g., such as if the ring members 29a, 29b are grabbed and pulled apart), the travel bar will be cammed rearward and allow the hinge plates to pivot. Thus in the position of FIGS. 8-11, the ring mechanism 1 is in a closed but unlocked position. It will be noted that as movement to this position occurs, the arms 50 and 51 do not yet apply upward force to the hinge plates 31a and 31b.

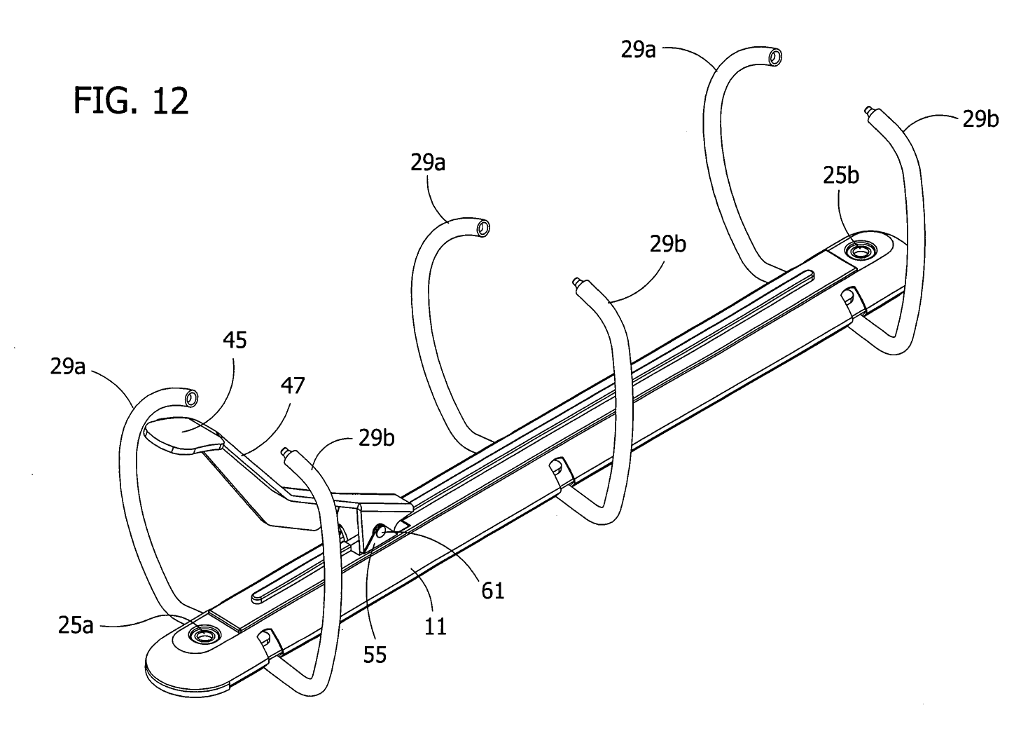

As lever 19 continues to be manually moved in the direction of the large arrows shown in FIGS. 12-15, the arms 50 and 51 begin to apply upward pressure to the hinge plates 31a and 31b to move them to the open position as illustrated in these figures. The travel bar 43 continues to be moved rearward by movement of pin 73 in slots 75a and 75b and the camming surfaces on the travel bar are moved further to the left so that the edges of slots 35a-c continue to move down the camming surfaces 63a, 65a and 67, allowing the hinge plates 31a and 31b to pivot to the open position shown in FIGS. 12-15. This movement also moves the ring members 29a and 29b to the open position. Movement of the binder mechanism from the unlocked to the locked position is simply accomplished by moving the lever 19 in the opposite direction so that the camming surfaces 63a, 65a and 67a force the hinge plates 31a and 31b to pivot downward to the closed position with the ring members 29a and 29b being in the closed position as shown in FIGS. 4-11.

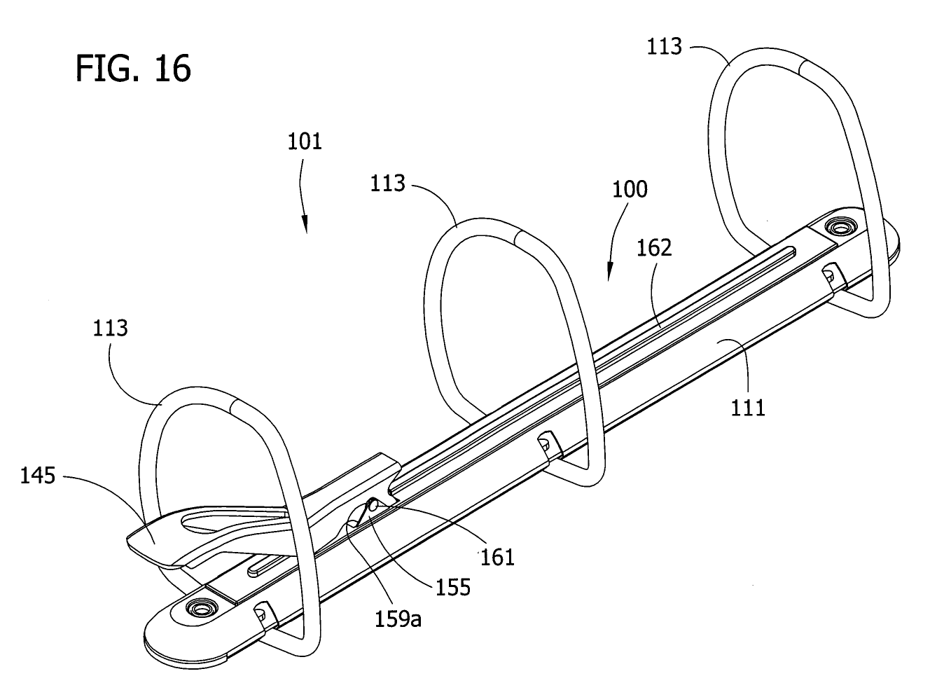

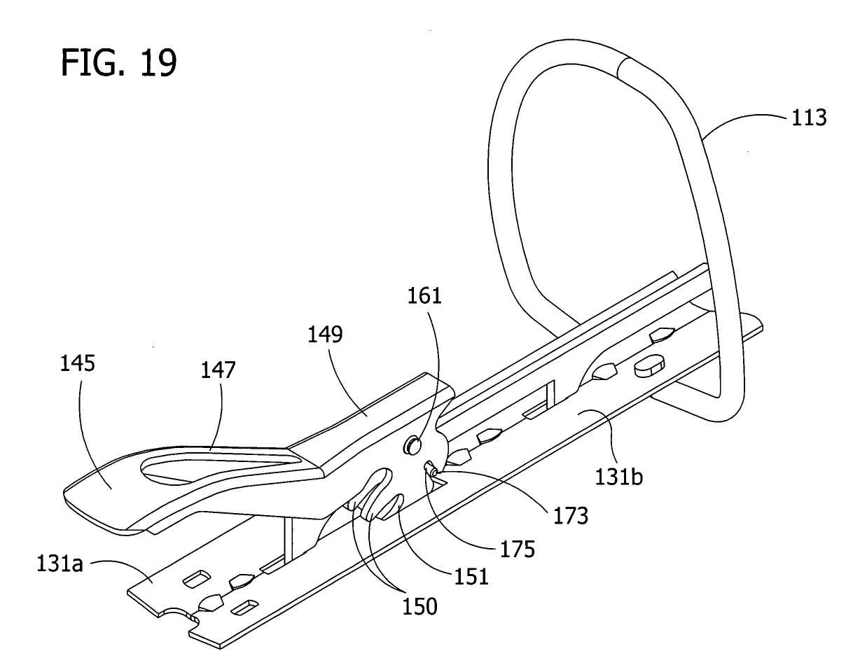

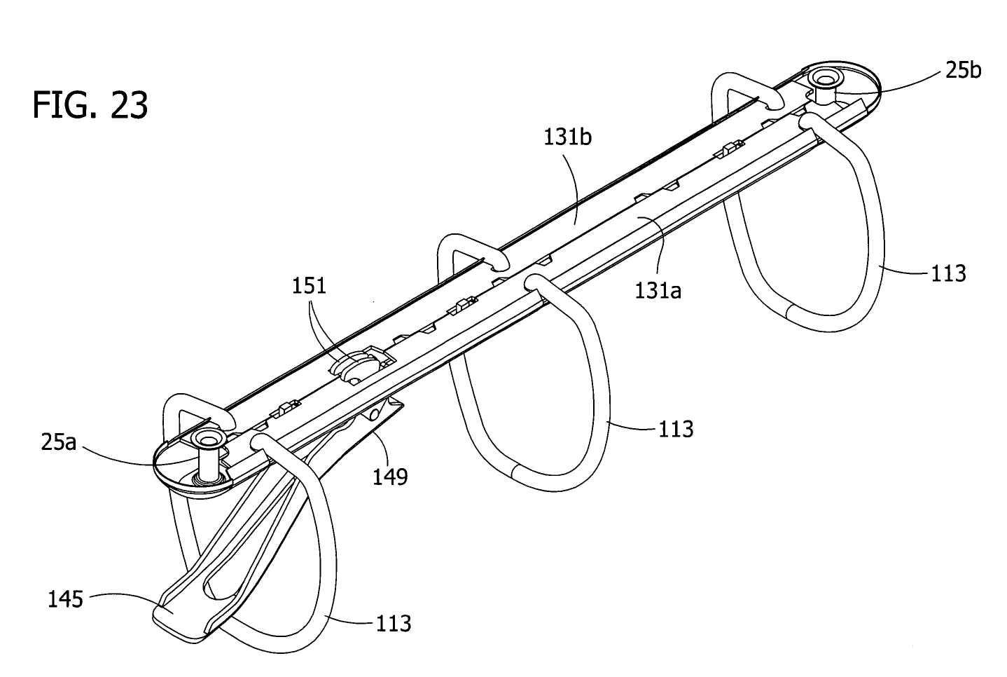

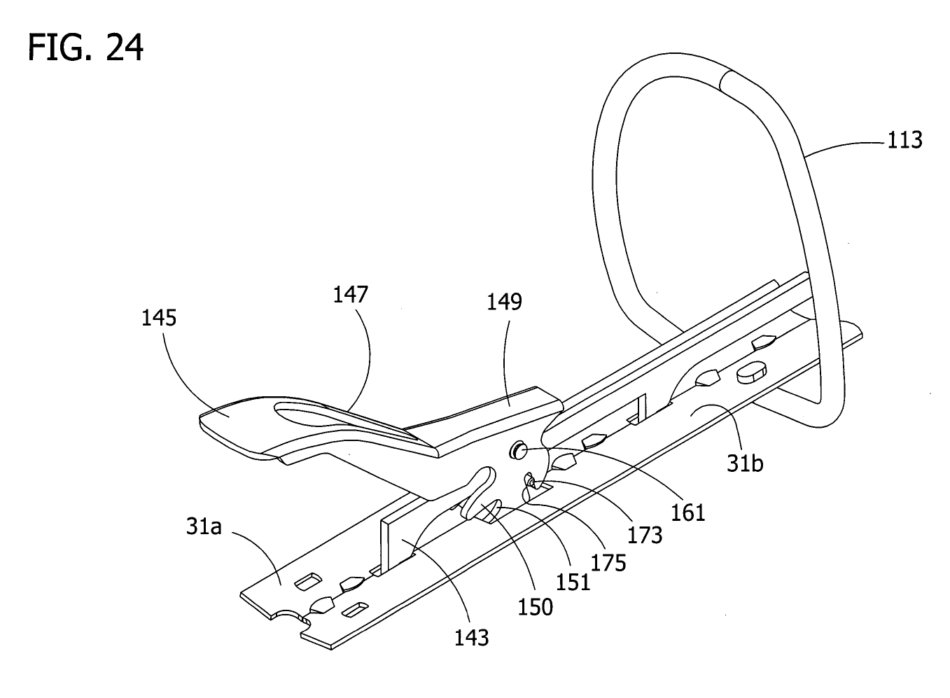

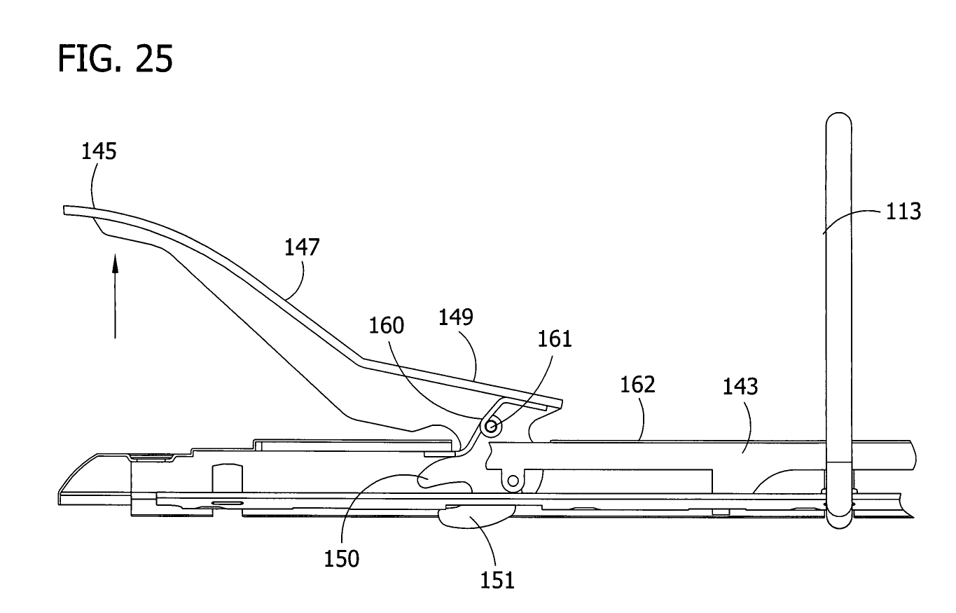

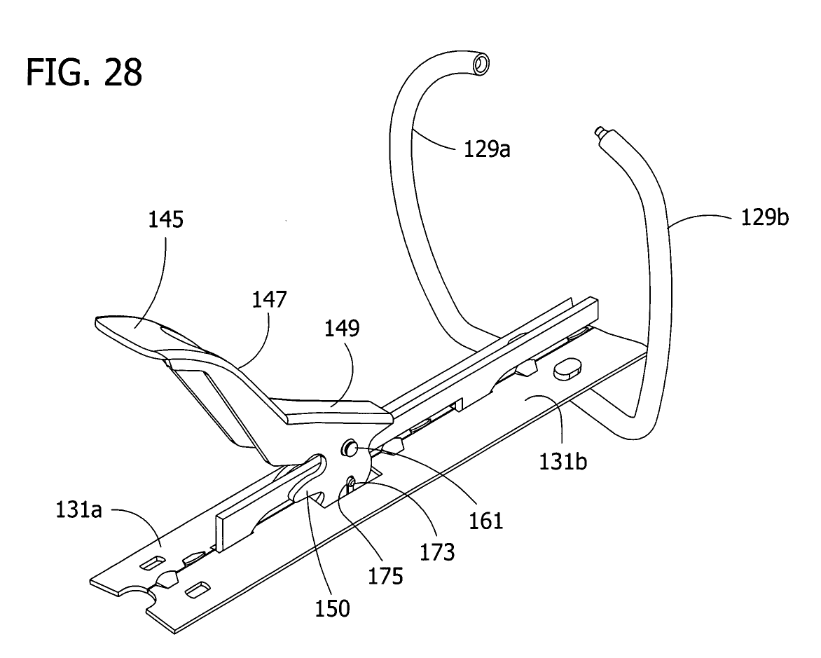

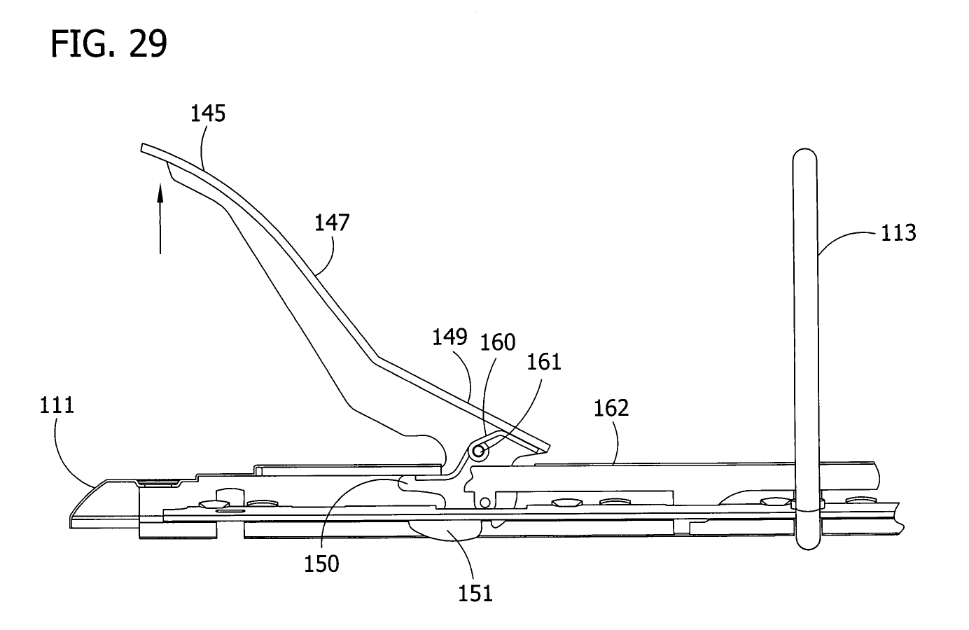

With reference to FIGS. 16-29 a second embodiment will now be described. As with the first embodiment, ring mechanism 101 generally includes an elongated housing 111, three substantially identical rings, each designated generally by reference numeral 113, and a control structure, designated generally by reference numeral 115. Housing 111 supports rings 113 and control structure 115 for closing and opening operation of mechanism 101 to retain, add, or remove pages. Parts of the mechanism 101 of the second embodiment corresponding to parts of the ring mechanism 1 of the first embodiment will be given the same reference numerals, plus “100”.

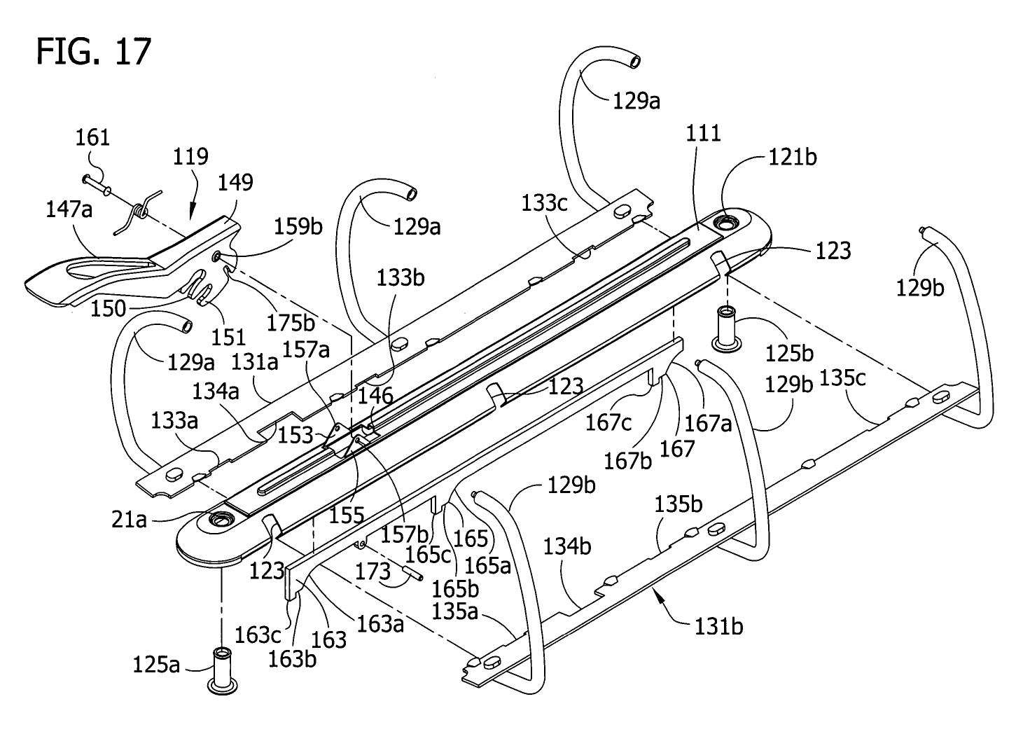

Referring to the exploded view of FIG. 17, components of ring mechanism 101 are shown. Housing 111 is elongate with a uniform, generally arch-shaped cross section having a central top portion and an open bottom generally opposed to the central top portion. Housing 111 also includes opposing longitudinal ends, both of which are closed with a rounded structure. An actuating lever 119 is mounted on the housing 111. Its structure and operation will be described in further detail hereinafter. A ring mechanism having a housing with a different shape, including an irregular shape, or a housing integral with a file or notebook is within the scope of this invention.

Housing 111 includes multiple openings, including two mounting post openings 121a, 121b and six ring openings, three on each side of housing 111, (each designated by reference numeral 123). Ring openings 123 (only three are shown) allow rings 113 to move relative to housing 111 to open and close during operation of ring mechanism 101. Mounting post openings 121a, 121b are located along the top surface of housing 111 toward opposite longitudinal ends. The openings 121a, 121b receive and attach mounting posts 125a, 125b, respectively, to housing 111 for use in securing mechanism 101 to a notebook spine 5 (e.g., as mechanism 1 in FIG. 1).

Housing 111 also includes two opposite, lower bent rims 126 (only one rim is visible in FIG. 17), extending along a respective longitudinal edge margin of the housing. As with the first embodiment, rims 126 support opening and closing movement of rings 113.

Also shown in FIG. 17 are ring members 129a, 129b that form each of rings 113. Ring members 129a each have a roughly semicircular, C-shaped profile, while ring members 129b each have a squared-off, half box-shaped profile as with the first embodiment. Together, the ring members 129a, 129b form what is known as a D-ring. It is envisioned that both ring members 129a, 129b are formed from a conventional, cylindrical rod of a suitable material such as steel. But ring members having different cross-sections or formed from different materials do not depart from the scope of the invention. In addition, a mechanism with more or less than three rings, or with rings that form a different shape when closed does not depart from the scope of this invention.

Hinge plates 131a, 131b each have substantially the same shape. Each is thin, flat, and generally rectangular, and each includes three cutouts 133a-c and 135a-c, respectively. Cutouts 133a-c are located in hinge plate 131a in spaced apart relation along an inner longitudinal edge margin of the hinge plate. Cutouts 135a-c are correspondingly located in hinge plate 131b along an inner longitudinal edge margin of the hinge plate. More particularly, cutouts 133a, 133c and cutouts 135a, 135c are located toward opposite longitudinal ends of respective hinge plates 131a, 131b. Cutout 133b and cutout 135b are located inward and between end cutouts 133a, 133c and end cutouts 135a, 135c, respectively. A further set of two cutouts 134a and 134b are formed in the edge margins of hinge plates 131a and 131b. As will be described in regard to operation of ring mechanism 101, the cutouts 134a and 134b accommodate portions of control structure 115 to allow either the pivoting movement of hinge plates 131a, 131b or block the pivoting movement.

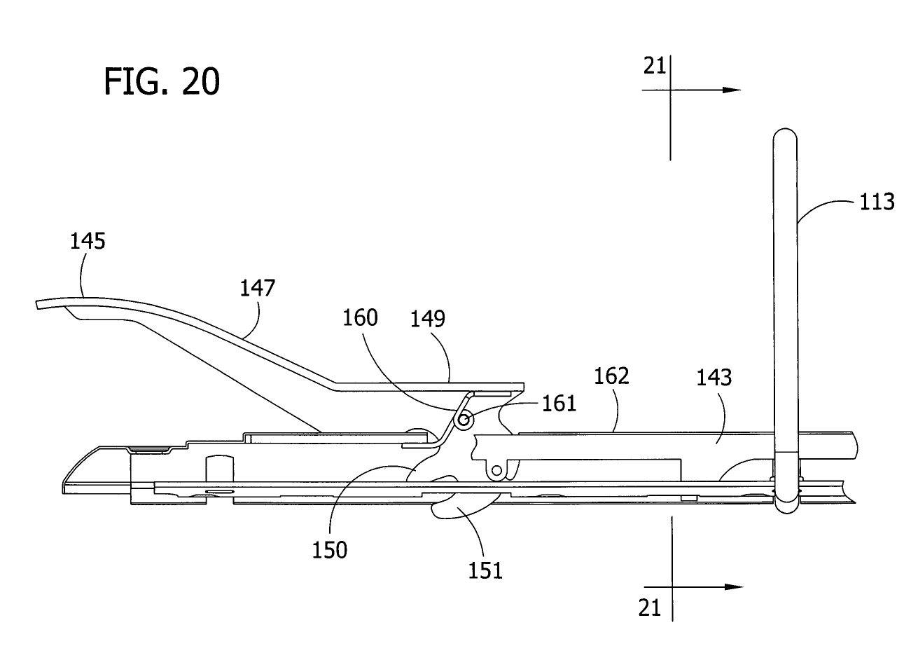

Control structure 115 will now be described with particular reference to FIGS. 16-21. The control structure is best shown in FIG. 17 and includes the actuating lever 119 and a travel bar, designated generally by reference numeral 143. As shown in FIG. 17, lever 119 has an enlarged head or handle portion 145, a main body 147 and an actuator portion 149 which extends through a rectangular opening 146 formed in the central top portion of housing 111. The main body 147 includes an elongated aperture 147a. Head 145 is curved to facilitate gripping lever 119 to pivot it. Actuator portion 149 is formed with two pairs of opposed generally hooked shaped arms 150 and 151 which extend down from the main body 147 through opening 146 in housing 111 and cutouts 134a and 134b in hinge plates 131a and 131b. The upper pair of arms 150 are each engageable with a respective upper surface of a respective hinge plate 131a and 131b. The lower pair of arms 151 are each engageable with a respective lower surface of hinge plates 131a and 131b. Lever 119 is supported on housing 111 by a pair of tabs 153 and 155 which extend upward from opposite sides of opening 146. A pair of aligned holes 157a and 157b formed in tabs 153 and 155 are also aligned with holes 159 formed, respectively, in the actuator portion 149. A pin 161 passes through holes 157a, 157b and 159 to hold the lever 119 for pivotal movement. A spring 160 is also provided which is positioned within the actuating portion 149 between the pairs of arms 150 and 151 and mounted on pin 161. One end of the spring 160 is mounted to engage the lever 119 inside the actuator portion and the other end engages inside the housing 111 under the central top portion adjacent opening 146, as best seen in FIG. 20.

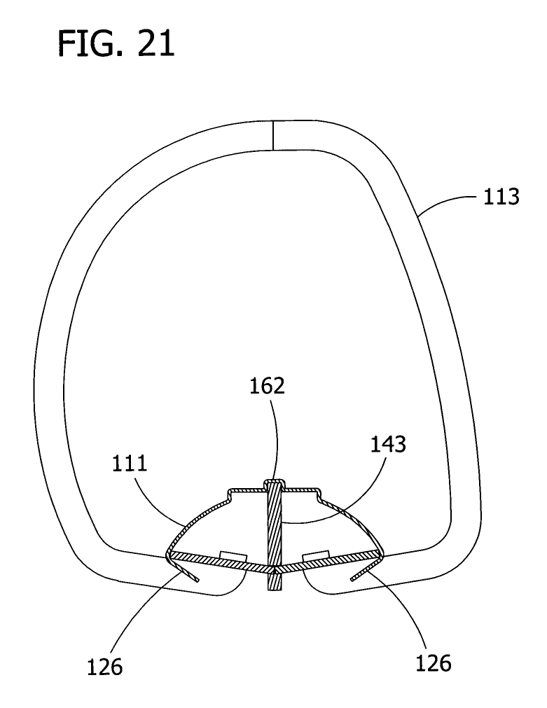

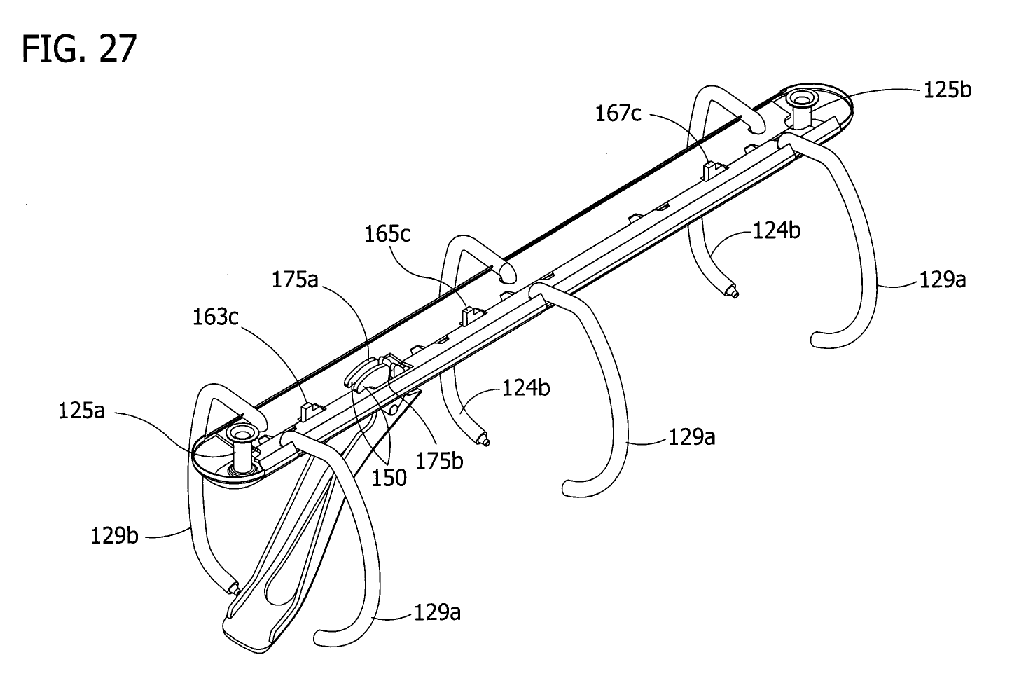

Referring again to FIG. 17, travel bar 143 is elongate, flat, and lies generally in a vertical plane (as oriented in FIG. 17). It is envisioned that travel bar 143 is stamped from a sheet of material, such as steel, and is free of bends. An upper edge of travel bar is flat and fits for sliding movement in a corresponding channel 162 (see FIG. 21) formed in the central portion of housing 111, while a lower edge of the travel bar includes three locking elements in the form of camming members 163, 165 and 167 formed in the travel bar. The camming members 163, 165 and 167 have respective curved camming surfaces 163a, 165a and 167a each extend to a flat 163b, 165b and 167b next to a rectangular stop 163c, 165c and 167c, respectively. A further protrusion 169 is also formed in the lower edge of travel bar 143 and forms a hole 171 in which a pin 173 is force fitted whose ends are aligned with and received in slots 175a and 175b (see FIG. 27) formed in respective pairs of arms 150 and 151 of actuator portion 149.

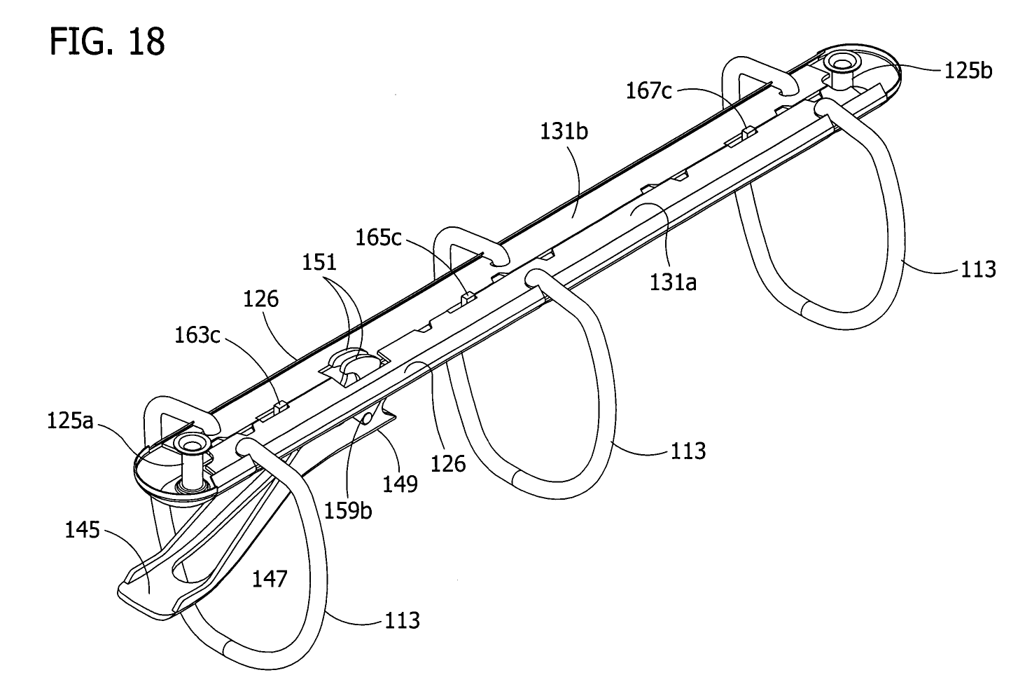

As shown, for example, in FIGS. 18 and 21, the hinge plates 131a, 131b are interconnected in parallel arrangement along their inner longitudinal edge margins, forming a central hinge. This is done in a conventional manner known in the art. The hinge plates 131a, 131b can pivot about the central hinge upward and downward. The six cutouts 133a-c and 135a-c in each of the two individual hinge plates 131a, 131b align to form three openings in the interconnected hinge plates. As with the first embodiment, housing 111 supports the interconnected hinge plates 131a, 131b with the bent rims 126 within the housing below the travel bar 143. The outer longitudinal edge margins of the hinge plates 131a, 131b loosely fit behind the bent under rims 126 of the housing 111 for allowing them to move within the rims when the hinge plates pivot.

Travel bar 143 is disposed above hinge plates 131a, 131b in general alignment with the hinge line formed by the margins of the hinge plates and, as mentioned above, its upper surface is received in the channel 162 formed in the central portion of housing 111 for sliding movement therein. A vertical plane containing travel bar 143 is oriented generally perpendicular to hinge plates 131a, 131b when in their coplanar position. Camming members 163-165 extend downward from travel bar 143 through respective cutout openings 133a-c and 135a-c of hinge plates 131a, 131b. As shown in the cross-sectional view of FIG. 21, travel bar 143 is held in position within channel 162 by the spring bias applied by the hinge plates 131a and 131b based on their containment within housing 111 and the force applied to the hinge plates from the flexibility of housing 111.

In operation, starting with the binder mechanism 101 in the closed and locked position, as illustrated in FIGS. 16-23, the travel bar 143 is positioned as far to the right as possible, as viewed in these figures, with the stops 163c, 165c and 167c of camming members 163-167 engaging the hinge plates 131a and 131b at the right end of the slots 135a-c so that the flats 163b, 165b and 167b lie against the upper surface of the hinge plates to prevent the hinge plates from being pivoted to open the rings 113. Thus, the mechanism is in the locked position. Note, as illustrated in FIG. 18, that the pair of arms 150 are out of engagement with and spaced from the hinge plates, but the pair of arms 151 engage the upper surfaces of respective hinge plates 131a and 131b in this position. The flats 163b, 165b and 167b operate to lock the ring members 129a, 129b in the same way as the flats 63b, 65b and 67b of the first embodiment.

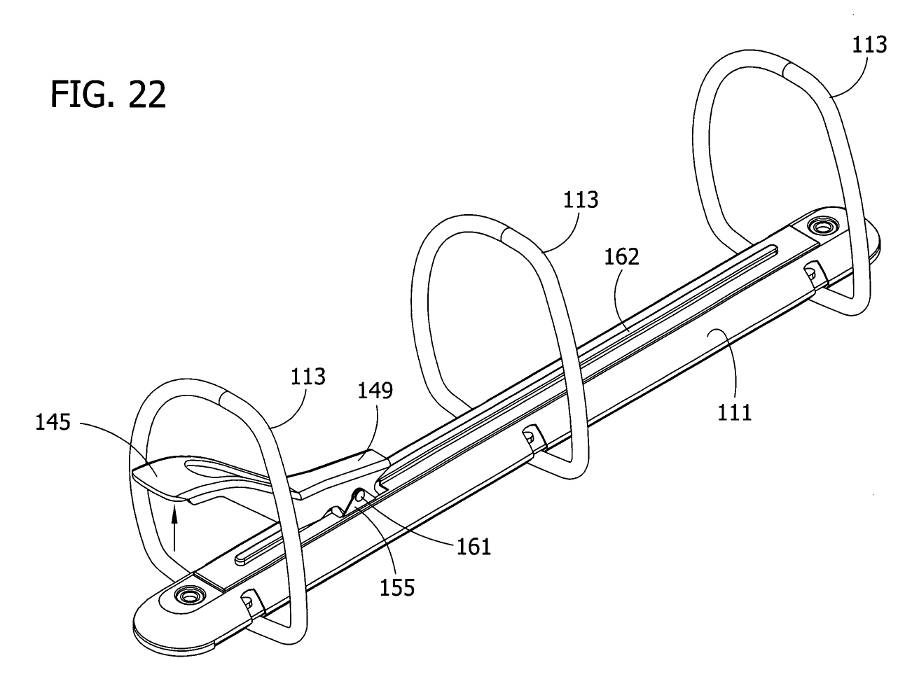

As seen in FIG. 22-25 as manual pressure is applied to head 145 of lever 19 as shown by the large arrows in FIGS. 22-25 the pair of arms 151 of actuating portion 149 of lever 119 move into engagement with the lower surfaces of hinge plates 131a and 131b. At the same time, travel bar 143 is moved rearward (to the left) by movement of pin 173 in slots 175a and 175b in arms 151 and the flats 163b, 165b and 167b move into the openings formed by the cutouts 133a-c and 135a-c. The camming surfaces 163a, 165a and 167a on the travel bar 143 are also moved rearward so that the edges of slots 135a-c engage the camming surfaces 163a, 165a and 167a. As with the mechanism 1 of the first embodiment, the mechanism 101 of the second embodiment is now in a closed but unlocked position in which the ring members 129a, 129b can be moved between their closed and open positions.

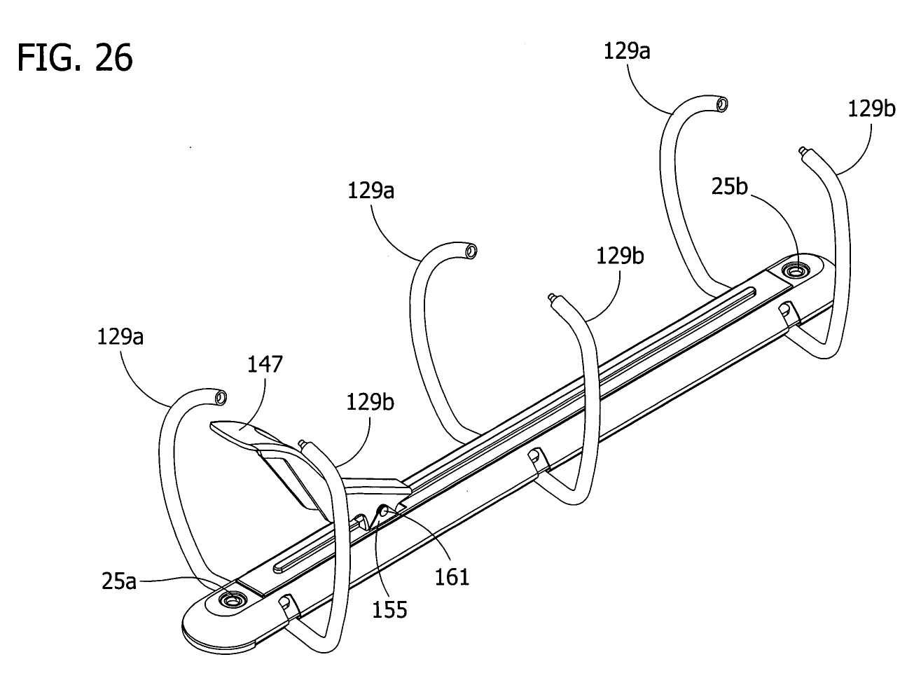

As lever 119 continues to be manually moved in the direction of the large arrows shown in FIGS. 26-29, the pair of arms 151 apply upward pressure to the hinge plates 131a and 131b to move them to the open position as illustrated in these figures. The travel bar 143 continues to be moved to the left by movement of pin 173 in slots 175a and 175b and the camming surfaces on the travel bar are moved further to the left so that the edges of slots 135a-c continue to move down the camming surfaces 163a, 165a and 167a and thus unlock the hinge plates 131a and 131b so that they can be pivoted by the pair of arms 151 to the open position shown in FIGS. 26-29. This movement also moves the ring members 129a and 129b to the open position.

Movement of the binder mechanism 101 from the unlocked to the locked position is slightly different from in the first embodiment as a result of the operation of the pair of arms 150. As with the first embodiment, moving the lever 119 in the opposite direction from the large arrows shown in FIGS. 22-29 causes the camming surfaces 163a, 165a and 167a to force the hinge plates 131a and 131b to the closed position with the ring members 129a and 129b being closed as shown in FIGS. 18-22. In addition, as lever 119 is manually moved toward the closed position, arms 150 engage the upper surfaces of respective hinge plates 131a and 131b to force them to pivot to the closed position. Furthermore, spring 160 provides additional biasing force to move the lever 119, travel bar 143 and hinge plates 131a and 131b into the closed position and maintain it in that position.

Components of ring binder mechanisms 1 and 101 as examples of the invention are made of a suitable rigid material, such as a metal (e.g. steel). But mechanisms having components made of a nonmetallic material, specifically including a plastic, do not depart from the scope of this invention.

When introducing elements of the invention, the articles “a”, “an”, “the” and “said” are intended to mean that there are one or more of the elements. The terms “comprising”, “including” and “having,” and variations thereof, are intended to be inclusive and mean that there may be additional elements other than the listed elements. Moreover, the use of “up”, “down”, “vertical”, “horizontal”, and variations of these terms is made for convenience, but does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A ring mechanism for retaining loose-leaf pages, the mechanism comprising:
a housing having a longitudinal axis, a central top portion having an opening defined therein and an open bottom generally opposed to the central top portion;
a pair of hinge plates each having an upper surface and a lower surface, the hinge plates being supported by the housing for pivoting movement relative to the housing with an upper surface of each hinge plate facing the housing;
at least one ring for holding loose-leaf pages, the ring including a first ring member and a second ring member, the first ring member being mounted on a first hinge plate and moveable with the pivoting motion of the first hinge plate relative to the second ring member between a closed position and an open position, in the closed position the two ring members forming a substantially continuous, closed loop for allowing loose-leaf pages retained by the ring to be moved along the ring from one ring member to the other, and in the open position the two ring members forming a discontinuous, open loop for adding or removing loose-leaf pages from the ring;
a travel bar disposed within the housing and supported for movement translationally along the longitudinal axis of the housing, the travel bar being adapted to affect the pivoting motion of the hinge plates; and
an actuating lever secured for pivotal movement to the housing, the actuating lever having a handle portion projecting above the housing for allowing manual pivotal movement of the actuating lever, and an actuator portion extending through the opening in the central top portion of the housing and engageable with the hinge plates to pivot them between the open and closed positions and further operatively connected to the travel bar to move the travel bar generally along the longitudinal axis of the housing.

2. A ring mechanism as set forth in claim 1 wherein the travel bar is shaped and arranged to lock the hinge plates in the closed position of the ring members.

3. A ring mechanism as set forth in claim 1 wherein the travel bar is shaped and arranged to cause the pivoting motion of the hinge plates upon movement of the travel bar generally along the longitudinal axis of the housing.

4. A ring mechanism as set forth in claim 1 wherein the actuating lever includes a slot receiving a portion of the travel bar therein for moving the travel bar.

5. A ring mechanism as set forth in claim 4 wherein the travel bar includes a pin projecting laterally outwardly from the travel bar and received in the slot of the actuating lever.

6. A ring mechanism as set forth in claim 1 wherein at least one of the hinge plates has an opening defined therein and the actuator portion of the actuating lever passes through the opening and has at least one first arm which extends beneath and is engageable with a lower surface of at least one of the hinge plates to move the hinge plates from the closed position to the open position.

7. A ring mechanism as set forth in claim 6 wherein the actuator portion of the actuating lever has at least one second arm which extends above and is engageable with an upper surface of at least one of the hinge plates to move the hinge plates from the open position to the closed position.

8. A ring mechanism as set forth in claim 1 further comprising a spring engaging the actuating lever and the housing so as to bias the actuating lever to move the travel bar toward its locked position.

9. A ring mechanism as set forth in claim 1 wherein the travel bar has an upper edge and a lower edge and the housing defines a channel in which the upper edge of the travel bar is disposed for translational movement along the longitudinal axis of the housing and the hinge plates engage the lower edge of the travel bar to bias the upper edge into engagement with the channel in the housing.

10. A ring mechanism as set forth in claim 1 wherein both of the hinge plates has an opening defined therein aligned with each other and the actuator portion of the actuating lever passes through the openings and comprises a pair of first arms which extend beneath and are each engageable with a lower surface of a respective hinge plate to move the hinge plates from the closed position to the open position.

11. A ring mechanism as set forth in claim 11 wherein the actuator portion of the actuating lever further comprises a pair of second arms which extend above and are each engageable with an upper surface of a respective hinge plate to move the hinge plates from the open position to the closed position.

12. A ring mechanism as set forth in claim 11 wherein the actuating portion of the actuating lever defines at least one slot and the travel bar includes a pin cooperatively engageable in the at least one slot in the actuating lever to move the travel bar between the locked and unlocked positions of the travel bar.

13. A ring mechanism as set forth in claim 12 further including a spring engaging the actuating lever and the housing so as to bias the actuating lever to move the travel bar toward its locked position.

14. A ring mechanism as set forth in claim 1 wherein the travel bar is formed from sheet material.

15. A ring mechanism as set forth in claim 1 in combination with a cover, the ring mechanism being mounted on the cover, the cover being hinged for movement to selectively cover and expose loose-leaf pages retained on the ring mechanism.
